(19) United States
(12) Patent Application Publication
(10) Pub. No.: US 2026/0318829 A1
(43) Pub. Date: Oct. 15, 2026

(54) CHEMOMETRICS DETERMINATION OF DISSOLVED GASES IN FLUID USING CAVITY-ENHANCED SPECTROSCOPY DEVICE

(71) Applicant: Neo Blue Technologies Inc., Los Angeles, CA (US)

(72) Inventors: James Mock, New York, NY (US); Charles Harb, Albuquerque, NM (US)

(73) Assignee: Neo Blue Technologies Inc., Los Angeles, CA (US)

(21) Appl. No.: 19/467,899

(22) Filed: Feb. 3, 2026

Related U.S. Application Data
(60) Provisional application No. 63/757,608, filed on Feb. 12, 2025.

(51) Int. Cl. G01N 21/39

(52) U.S. Cl. CPC G01N 21/39; G01N 2021/391

(57) ABSTRACT

An autonomous underwater vehicle (AUV) implementing a method for determining chemometrics is disclosed. The method includes collecting a gas sample into a cavity of the cavity-enhanced spectroscopy (CES) device, injecting light into the gas sample in the cavity, by one or more lasers of the CES device, to obtain one or more ringdown signals, and determining an observed spectra for the gas sample based on absorption of the injected light. Then chemometrics of the gas sample are determined by processing, via an artificial intelligence (AI) model, the observed spectra and/or environmental parameters of the gas sample. The light is modulated for ringdown signal processing, and AI models are adapted for drift correction, chemometric determination, and time-lag corrections.

### TECHNICAL FIELD

The present disclosure relates to spectrometry. In particular, the present disclosure relates to a system and a method for chemometrics of dissolved gases in a fluid using a cavity-enhanced spectroscopy (CES) device.

### BACKGROUND

The determination of molecular composition, or chemometrics, of gaseous substances has commercial relevance across a wide range of scientific, industrial, and environmental applications. Spectroscopic techniques/devices are used to determine chemometrics, such as absorption spectroscopy that infers the molecular composition of the gases based on absorption of light at specific wavelengths. By analyzing the absorption spectrum of a gas sample, the constituent components and quantity of the target molecules or gases may be identified.

Conventional spectroscopic instruments, especially those capable of high-precision isotopic ratio measurements, often suffer from significant limitations, particularly concerning their deployment in challenging environments. Many existing systems are bulky and power-hungry laboratory-based instruments, ill-suited for in situ or portable applications. The large footprint and high-power demand of conventional solutions become especially problematic when considering deployment in remote locations, on mobile platforms such as autonomous underwater vehicles (AUVs), or for continuous, long-term monitoring in resource-constrained settings. The physical size and weight of traditional spectrometers often preclude their integration into compact systems or deployment on platforms with limited payload capacity. Furthermore, their sensitivity to environmental conditions can necessitate complex and energy-intensive environmental control systems, further exacerbating the size and power consumption issues.

Beyond the physical constraints, traditional spectroscopic analysis methods also present significant computational burdens. Techniques for signal processing, such as fitting exponential decay curves in spectroscopic devices, and chemometric analysis, like iterative spectral fitting, are often computationally intensive.

In traditional solutions, the decay time constant is estimated by fitting an exponential decay model to each ringdown time series, often using least-squares optimization algorithms, such as the Levenberg-Marquardt (LM) method. To improve measurement precision, absorption values derived from individual cycles are aggregated-commonly via averaging-over a defined sampling window. While effective, these methods are computationally intensive, particularly for real-time or in situ applications. The total runtime scales linearly with the number of ringdown cycles under ideal conditions, assuming consistent convergence behavior. However, in practice, the number of iterations required for convergence often depends on the quality of initial parameter estimates and the noise level of the data, which can significantly impact runtime. Such solutions are infeasible, particularly for real-time analysis, and in low-power or resource constrained contexts.

Similarly, existing solutions for determining concentration of gases and molecular ratios are also computationally demanding. Existing solutions use iterative spectral fitting methods to quantify concentrations in complex mixtures with overlapping spectra. These methods begin with a predefined list of gases in the sample, along with known temperature and pressure conditions. Using high-resolution spectral databases like high-resolution transmission molecular absorption database (HITRAN), theoretical spectral profiles are generated for each gas under observed environmental conditions, and the observed spectra is modeled as a weighted sum of individual gas spectra, with weights corresponding to their concentrations or relative abundances. These weights are iteratively refined using optimization algorithms, such as least-squares minimization, to minimize the residuals between the synthetic spectrum and the observed data. As stated, such optimization algorithms are computationally intensive, and are infeasible for in-situ, real-time chemometric detection applications. The problem is exacerbated since the temperature and the pressure do not remain constant, thereby further increasing the computational complexity of the fitting methods.

Also, existing spectroscopic devices having membrane-inlet samplers inherently have response-time delays, which are delays between measuring diffusion of dissolved gases in the target fluid and measurements thereof. Since the rate of gas diffusion (or diffusion kinetics) across membrane-inlet samplers is relatively slow, and variable with respect to environmental conditions, the concentration of gasses within the instrument may not immediately reflect their ambient dissolved concentrations. Existing solutions to minimize response time delays include use of (vacuum) pumps to increase rates of diffusion. However, such solutions are power-intensive, and make the spectroscopic devices bulky, thereby making them unsuitable for remote and/or autonomous sensing applications. Additionally, such devices may also have instrument drift errors over time, due to instrument aging, thermal and mechanical stress, calibration errors, and the like, but not limited thereto. Such instrument drifts need to be accounted for in real-time, and in-situ, without the need for external calibration devices.

Hence, there is a need for more efficient solutions for determining chemometrics in real-time, and/or in-situ, of dissolved gases in fluids.

### SUMMARY

An aspect of the present disclosure relates to a method for determining chemometrics of dissolved gases in a fluid using a cavity-enhanced spectroscopy (CES) device. The method includes collecting a gas sample into a cavity of the CES device, injecting light into the gas sample in the cavity, by one or more lasers of the CES device, to obtain one or more ringdown signals, determining an observed spectra for the gas sample based on absorption of the injected light, and determining chemometrics of the gas sample by processing, via an artificial intelligence (AI) model, the observed spectra and/or environmental parameters of the gas sample. The method allows for accurate and drift-corrected measurements of dissolved gases in fluids, and improved/accurate measurement of chemometrics.

In some embodiments, the environmental parameters may be one or more of temperature and pressure.

In some embodiments, the determined chemometrics may be at least one of molecular ratios and/or concentration of gases.

In some embodiments, for determining the decay time, the method may include modulating spectral properties of light being injected into the cavity according to a predictable set of harmonic frequencies such that harmonic amplitudes of the one or more ringdown signals are modulated, and determining the decay time based on a ratio of peak amplitudes between selected harmonic pairs in frequency domain of the one or more ringdown signals.

In some embodiments, the light may be modulated to a square wave.

In some embodiments, the method may further include determining multiple ones of the decay time based on multiple successive ringdown signals from the one or more ringdown signals.

In some embodiments, the multiple ones of the decay time may be combined as a weighted sum based on a signal-to-noise ratio (SNR) of each harmonic in the one or more ringdown signals.

In some embodiments, the SNR may be determined by comparing the harmonic's amplitude to the noise in adjacent frequency bands.

In some embodiments, the method may further include adjusting the temperature of the one or more lasers to correct for instrument drift, the instrument drift being identified based on the environmental parameters and observed spectra, and where the temperature may be adjusted based on stability of the CES device.

In some embodiments, for identifying the instrument drift, the method may further include predicting one or more spectral metrics using corresponding pre-trained models based on the environmental parameters, and determining the instrument drift based on a comparison of the one or more predicted spectral metrics and corresponding observed spectral metrics derived from the observed spectra.

In some embodiments, the instrument drift may be determined by iteratively fitting the one or more predicted spectral metrics and the corresponding observed spectral metrics.

In some embodiments, for identifying the instrument drift, the method may further include processing the environmental parameters through a dense layer and the observed spectra through a convolutional layer of a hybrid model, combining the processed environmental parameters and the processed observed spectra through a concatenation layer of the hybrid model into combined features, and identifying the instrument drift based on processing of the combined features through other layers of the hybrid model.

In some embodiments, before combining the processed environmental parameters and the processed observed spectra, the method may include processing the one or more processed environmental parameters and the processed observed spectra through a corresponding recurrent layer.

In some embodiments, the AI model may be trained on a dataset associating any one or a combination of ratio of absorption values between one or more molecules, absolute absorption value of at least one of the one or more molecules, and the environmental parameters, and where the dataset may be built by combining empirical data and synthetic datasets.

In some embodiments, the AI model may include a set of ensemble models configured to output an estimated ratio associated with at least one spectral line per species based on the observed spectra and the environmental parameters, and a meta-regressor model configured to combine the estimated ratio from each ensemble model in the set of ensemble models to determine the chemometrics.

In some embodiments, the AI model may be configured to process each spectrum from the observed spectra through at least one corresponding convolutional layer, temporally process each of the processed spectra and the environmental parameters through at least one recurrent layer, combine each of the temporally processed spectra and the temporally processed environmental parameters through a concatenation layer, and determine the chemometrics of the gas sample based on processing of the combined spectra and environmental parameters through other layers of the AI model.

In some embodiments, the CES device may include a passive membrane-based sampler for collecting the gas sample from a water source, and where the method may further include moving the CES device through the water source to increase diffusion rate of dissolved gases in the water source for collecting the gas sample with minimal response time.

In some embodiments, the passive membrane-based sampler may include a hydrophobic membrane selected from polytetrafluoroethylene (PTFE) or polydimethylsiloxane (PDMS).

In some embodiments, the method may further include forecasting ambient gas concentrations in a water source from which the gas sample may be collected based on environmental telemetry data and the observed spectra over a predetermined interval of time, and correcting response time based on the forecasted ambient gas concentrations in real time.

In some embodiments, the environmental telemetry data may include any one or a combination of ambient temperature, internal temperature, depth-associated pressure, hydrostatic pressure, and salinity.

In some embodiments, each of the one or more lasers may be configured to emit light of a different range of wavelength.

An aspect of the present disclosure relates to an autonomous underwater vehicle (AUV), including a cavity-enhanced spectroscopy (CES) device, and a controller configured to cause the AUV to perform the method described above.

Other aspects of the disclosure will be apparent from the following description and the appended claims.

### BRIEF DESCRIPTION OF THE DRAWINGS

FIG. 1 illustrates an example cavity-enhanced spectroscopy (CES) device, according to embodiments of the present disclosure.

FIG. 2 illustrates a block diagram of a controller of the CES device, according to embodiments of the present disclosure.

FIG. 3 illustrates a flowchart of an example method of operation of the CES device for chemometrics determination, according to embodiments of the present disclosure.

FIGS. 4A and 4B illustrate example input laser intensity modulation and corresponding ringdown waveform thereof, according to embodiments of the present disclosure.

FIGS. 5A and 5B illustrate example architectures of AI models for chemometrics determination, according to embodiments of the present disclosure.

FIGS. 6A to 6C illustrate block diagrams of models for drift correction, according to embodiments of the present disclosure.

FIG. 7 illustrates an example computer system in which or with which the embodiments of the system may be implemented, according to embodiments of the present disclosure.

### DETAILED DESCRIPTION

The particulars shown herein are by way of example and for purposes of illustrative discussion of the various embodiments only and are presented in the cause of providing what is believed to be the most useful and readily understood description of the principles and conceptual aspects of the methods and compositions described herein. In this regard, no attempt is made to show more detail than is necessary for a fundamental understanding, the description making apparent to those skilled in the art how the several forms may be embodied in practice.

The present disclosure will now be described by reference to more detailed embodiments. The present disclosure, however, is embodied in different forms and should not be construed as limited to the embodiments set forth herein. Rather, these embodiments are provided so that this disclosure will be thorough and complete, and will fully convey the scope to those skilled in the art.

Unless otherwise defined, all technical and scientific terms used herein have the same meaning as commonly understood by those skilled in the art to which the present disclosure belongs. The terminology used in the description herein is for describing particular embodiments only and is not intended to be limiting. As used in the description and the appended claims, the singular forms ‘a,’ ‘an,’ and ‘the’ are intended to include the plural forms as well, unless the context clearly indicates otherwise.

Unless indicated to the contrary, the numerical parameters set forth in the following specification and attached claims are approximations that may vary depending upon the desired properties sought to be obtained and thus may be modified by the term about. At the very least, and not as an attempt to limit the application of the doctrine of equivalents to the scope of the claims, each numerical parameter should be construed in light of the number of significant digits and ordinary rounding approaches.

Conventional instruments for chemometrics are large, power-hungry, computationally expensive, and sensitive to environmental conditions. As a result, conventional instruments are ill-suited for in situ use, such as in autonomous underwater vehicles (AUVs).

The present disclosure relates to a membrane-inlet, cavity-enhanced, tunable diode laser absorption spectrometer (“TDLAS”) that quantifies chemometrics, such as molecular ratios, of dissolved gases in the ocean water column. The present disclosure addresses at least the above-mentioned problems by modulating light waveform for a ringdown signal processing, and using artificial intelligence (AI) engines adapted for environmentally resilient chemometric analysis systems, thereby providing accurate real-time measurements with minimal power consumption. The present disclosure also performs real-time drift correction/response time correction, to improve accuracy of the data. The present disclosure, provides a compact and low-power design that is accurate, processes data in real-time, and makes longitudinal chemical data collection possible in extreme environments, especially for robotic platforms like AUVs. Further, various embodiments of the present disclosure are suitable for measurement of hydrocarbons, carbon dioxide, helium, and other gases relevant to energy exploration, carbon capture and storage, earthquake detection, and numerous other geologic and industrial endeavors.

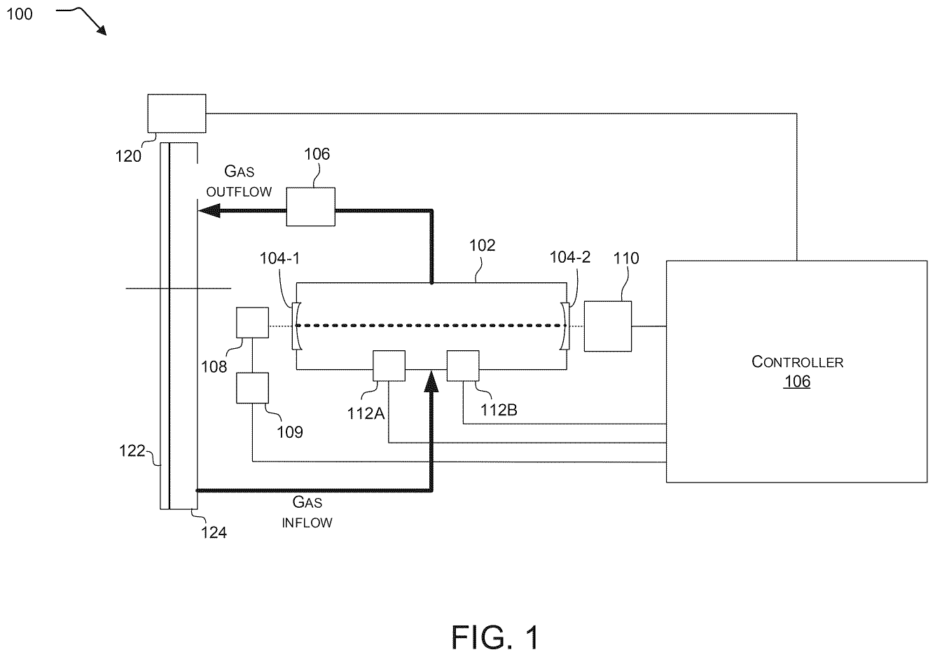

Various embodiments of the present disclosure are described in detail in reference to FIGS. 1 to 7.

Referring to FIG. 1, an example AUV 100 adapted to determine chemometrics of dissolved gases in a fluid is shown. The AUV 100 may include a cavity-enhanced spectroscopy (CES) device having a membrane 122 configured to filter/extract a gas sample from a volume of fluid. The membrane 122 may be attached to a sintered disk 124. A thermistor 120 may be disposed proximate to the membrane 122 to measure ambient temperature or the temperature of the fluid. The CES device also includes a gas measurement cell or a cavity 102 configured to allow the gas sample to be accommodated therein and/or flowed therethrough, and one or more lasers (such as laser 108) configured to inject light into the gas sample inside the cavity 102. The cavity 102 may include mirrors 104-1, 104-2 configured to reflect light within the cavity 102. An optical detector 110 may be configured to detect the intensity of light injected into the cavity 102 and reflected between the laser 108, for determination of ringdown time of the gas sample. Additionally, or alternatively, the CES device may include multiple sensors to measure/collect environmental parameters, such as pressure sensors 112A and thermistors/temperature sensors 112B for measuring pressure and temperature of the gas sample within the cavity 102, aside from the thermistor 120. In some embodiments, the CES device may include or be operated by a controller 106, which may be communicatively coupled to, among other components, such as the laser 108 (either directly or through a laser driver 109), the sensors (such as 112A, 112B, and 120), and the optical detector 110. The controller 106 may be configured to determine chemometrics associated with the gas sample by controlling the laser 108, and processing the environmental parameters received from the sensors and the optical detector 110. Examples for chemometrics may include molecular ratio, and concentration of gases, but not limited thereto.

In some embodiments, the membrane 122 may be a permeable layer or a substrate defined on an opening/inlet associated with the CES device/AUV 100, through which the dissolved gases may be extracted from the volume of the fluid. The membrane 122 may be porous to selectively permeate/filter dissolved gases in the fluid therethrough, the permeated dissolved gases being used as gas samples.

In some embodiments, the membrane 122 may be a passive membrane-based sampler for collecting the gas sample from the fluid source. Using passive membrane-based samplers may allow the flow of the fluid across the membrane 122 while minimizes local boundary layer effects, without relying on active pumping. The passive-membrane allows the dissolved gases to be extracted from the fluid passively.

In some examples, the fluid source or the volume of fluid filtered by the membrane 122 may be indicative of a column of seawater or ocean water. In such examples, the column of seawater may be used for energy exploration, i.e., to identify potential seafloor/ocean floors having fossil fuels, natural gas, and other natural resources, based on presence of molecules, such as methane among other hydrocarbons, in the gas sample. In other embodiments, the volume of fluid may correspond to any other gas or liquid for which chemometrics are needed.

In some embodiments, the passive membrane-based sampler (i.e., the membrane 122) may be a hydrophobic membrane selected from polytetrafluoroethylene (PTFE) or polydimethylsiloxane (PDMS), but not limited thereto. The use of hydrophobic layers may repel, and thereby prevent, water (in the fluid) from permeating therethrough, while allowing other dissolved gases within the water/fluid to separate and pass through the membrane 122 for further processing.

In some embodiments, the sintered disk 124 may be attached to the membrane 122. The sintered disk 124 may be configured to provide mechanical support to the membrane 122, such as to prevent deformation of the membrane 122 under hydrostatic pressures of the fluid. The sintered disk 124 may be made of metals, such as stainless steel. The geometric profile of the sintered disk 124 may be selected based on that of the membrane 122, and optimized to provide structural support thereto.

In some embodiments, the driving force that causes the fluid to interface with the membrane 122 may be the fluidic/hydrostatic pressure in the ambient environment/fluid source in which the AUV 100 is deployed. For example, when the AUV 100 is deployed in seawater or oceanwater, the pressure exerted by the surrounding water may facilitate the interaction between the fluid and the membrane 122. The gas exchange between the CES device/AUV 100 and volume of fluid may occur based on partial pressure gradients across the membrane 122. For example, if the concentration of a gas is lower in the water than in the cavity 102, the gas may diffuse out of the CES device until equilibrium is reached, and vice-versa.

In another embodiment, the driving force may be generated by the movement of the AUV 100, as the AUV 100 is lowered towards the ocean floor. The AUV 100 may be oriented such that the membrane 112 is pointed towards the ocean floor. In such embodiments, as the AUV 100 descends, the water column against which the membrane 122 is pushed increases the pressure, allowing for more effective fluid transfer and interaction with the membrane 122. Moving the CES device/AUV 100 through/against the fluid may increase diffusion rate of dissolved gases in the fluid through the membrane, thereby collecting the gas sample with minimal response time. In further embodiments, the dissolved gases from the fluid source may be permeated through the membrane 122, as the AUV 100 is moved within the fluid source. For example, the AUV 100 may be moved horizontally across different columns of water, with the membrane 122 allowing dissolved gases in each of the columns to be permeated therethrough as the AUV 100 is moved.

While the embodiments of the present disclosure are described in the context of the CES device having membrane-based samplers, other sampling mechanisms capable of separating dissolved gases may be substituted without altering the measurement processes of the present disclosure.

In some embodiments, the temperature of the ambient environment or of the fluid may be measured by the thermistor 120. The thermistor 120 may be placed proximate to the membrane 122. The thermistor 120 may be connected to the controller 106, which may use the temperature of the fluid source to determine the chemometrics of the fluid source. While a thermistor is used to measure temperature of the ambient environment/fluid in FIG. 1, it may be appreciated that the AUV 100 may be suitably adapted to determine the temperature of the ambient environment/fluid through other temperature sensors. Further, other sensors (not shown), such as those for determining pressure, humidity, salinity, and the like, of the fluid/ambient environment may also be included on the CES device, and used for determination of the chemometrics of the dissolved gases therein.

In some embodiments, the membrane 122 and the cavity 102 may be fluidically connected. The fluidical connection may enable the dissolved gases permeated through the membrane 122 to be flowed into and/or through the cavity 102. The fluidical connection may be made through pipes and/or channels. In some embodiments, a pump may be connected to the fluidical connection, to facilitate the circulation of the gas between the membrane 122 and the cavity 102. The fluidical connection may also enable the cavity 102 to remove/discard/expend the dissolved gases therein. The expended dissolved gases from the cavity 102 may be released back to the fluid source through the membrane 122. In some embodiments, different portions of the membrane 122 may be used to allow the dissolved gases to enter and exit the AUV 100/cavity 102. In other embodiments, multiple ones of the membrane 122 may be used, one for allowing the dissolved gases to enter into the AUV 100, and the other for the expended dissolved gases to be released back to the fluid source. The fluidical connection, hence, allows the dissolved gases from fluid source to be continually circulated between the fluid source and the cavity 102, through the membrane 122.

In some embodiments, the sensors 112A and 112B, and the thermistor 120 (among other sensors not shown in FIG. 1) may be configured to collect environmental parameters. The sensors may be configured to detect temperature and pressure. In some embodiments, the fluidical connections may include valves to control inflow and outflow of the dissolved gases. The valves may be opened and/or closed based on the temperature and/or the pressure detected by the sensors. In other embodiments, the temperature and/or the pressure of the dissolved gases within the cavity 102 may be used by the controller 106 for determining the chemometrics of the dissolved gases.

The dissolved gases provided to the cavity 102 may be used as a gas sample for chemometric determination. The gas sample may allow the AUV 100 to generate a chemometric profile for the corresponding fluid source (or column of water) from which the gas sample is extracted.

As shown in FIG. 1, the cavity 102 may be an optical cavity having the mirrors 104-1 and 104-2. The cavity 102 may have a substantially elongated geometric profile, such as a cuboidal or cylindrical profile. The mirrors 104-1, 104-2 may be disposed on opposite ends of the cavity 102, on a longitudinal axis thereof (i.e., the axis along the longest dimension of the cavity 102). The mirrors 104-1 and 104-2 may be configured to reflect light injected into the cavity 102 therebetween.

In some embodiments, light may be injected into the cavity 102 by the laser 108. The laser 108 may be configured to inject light having spectral attributes/properties (such as wavelengths) selected/determined by the controller 106. In some embodiments, the CES device may include multiple ones of the laser 108. In some embodiments, the laser 108 may be configured to emit light over a target spectral range. In other embodiments, multiple ones of the laser 108 may be implemented in the CES device, where each laser 108 may be configured to emit light within a subset of the target spectral range. In some embodiments, the spectral properties that the lasers 108 emit may be selected based on absorption profiles associated with target gases (i.e., gases that the AUV 100 is designed/deployed to detect and quantify, such as hydrocarbons, carbon dioxide, helium, and other gases of interest in subsea environments in the context of energy exploration, for example).

The controller 106 may be configured to control spectral properties of the light generated by the laser 108 using the laser driver 109. The laser driver 109 may be configured to regulate current (such as to modulate the spectral properties of the light emitted by the laser 108), maintain temperature of the laser 108 through thermoelectric coolers (for example), fine-tune laser power to optimize for signal-to-noise ratio, and the like, but not limited thereto.

In some embodiments, the waveform of the light may be modulated. For example, the light may be modulated to have a square waveform. The light having square 9 waveform may have a 50% duty cycle incident on the cavity 102. Due to the orthogonality of the sinusoids in the square waveform, each of the components thereof may be separately analyzed.

In some embodiments, the laser 108 may be caused/controlled (by the controller 106) to inject light continually at wavelengths that allow the light to resonate, or interfere constructively, within the cavity 102, such that intensity of light builds up. The laser 108 may then be shut down, to allow the intensity of light to decay. The intensity of the light may decay exponentially, as the light is reflected back-and-forth between the mirrors 104-1, and 104-2. Due to the back-and-forth reflection, the cavity 102 may provide an effective path length for extinction (in the order of a few kilometers, although the mirrors 104-1 and 104-2 may be separated by a few centimeters).

Further, the controller 106 may be connected to the optical detector 110, which may be configured to detect spectral attributes/properties of the light injected into and reflected between the mirrors 104-1 and 104-2 of the cavity 102. In such embodiments, one of the mirrors (such as mirror 104-2) may include an opening through which the optical detector 110 may be allowed to observe the light within the cavity 102. The optical detector 110 may be configured to quantify the absorption of the light by the gas sample at each wavelength. The optical detector 110 may be photodetector materials known to those skilled in the art. The materials making the optical detector 110 may be selected based on optical range of the laser 108. In some embodiments, the optical detector 110 may also include a thermoelectric cooler for cooling thereof.

In some embodiments, the optical detector 110 may be configured to determine an observed spectra from the gas sample, based on the absorption of the injected light. Further, in some embodiments, the optical detector 110 may generate one or more ringdown signals representing the intensity of the observed spectra. The ringdown signals may be collected by the controller 106 to determine time taken (i.e., decay time/decay time constant) for light to reach 1/e of the initial intensity of the light injected into the cavity 102. The decay time may be directly related to the optical losses within the cavity 102, due to absorption by the gas sample. In some embodiments, the ringdown signals may indicate absorption values for each wavelength (or a set of wavelength intervals) of the gas sample, i.e., using the intensity as an indicator of how much light of each wavelength has the gas sample absorbed.

In some embodiments, the presence of the gas sample within the cavity 102 may cause changes to the spectral properties of light. Each gas sample may absorb different wavelengths of light based on molecular composition thereof (i.e., molecular or isotropic ratios thereof), providing each gas sample with a unique spectral signature. The spectral signature may be represented as absorption lines on the observed spectra. For example, each type of molecule in the gas sample may absorb a corresponding ‘characteristic wavelength’, while reflecting other wavelengths in the injected light. When observed by the optical detector 110, the absorbed wavelengths may appear as ‘absorption’ lines on the observed spectra, given the intensity of the absorbed wavelength may be 0 or insignificant.

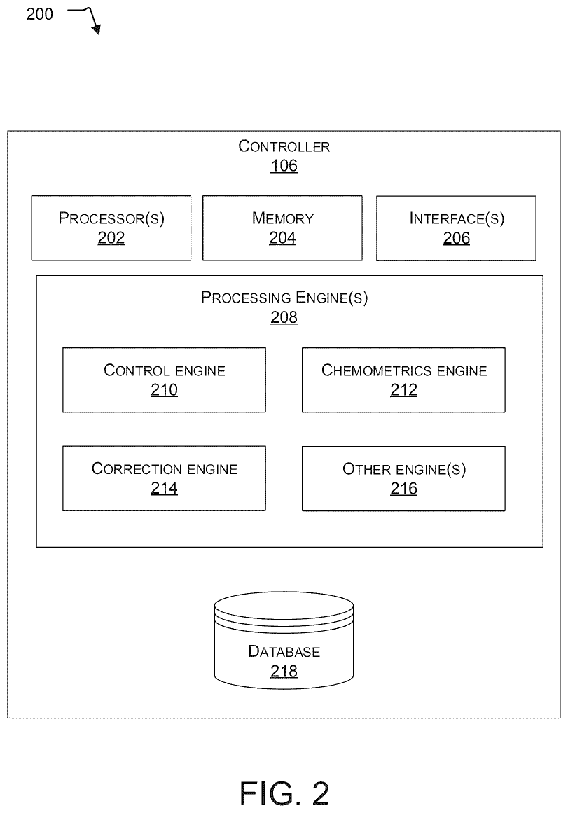

The controller 106 may be configured to use the observed spectra, the decay times, the environmental parameters, among other parameters, to determine the chemometrics (such as molecular ratios and concentrations) of the gas sample. The controller 106 may include an artificial intelligence (AI) model adapted to determine the chemometric profile of the gas sample based on the environmental parameters and/or the ringdown signals. Further details of the controller 106 are provided in reference to FIG. 2.

While FIG. 1 illustrates some of the units/components of the AUV 100, it may be appreciated by those skilled in the art that other components/units may be suitably adapted and included in the AUV 100 for the operation thereof. For example, the AUV 100 may include motors and other propulsion devices, sensors, and/or other controllers configured to enable the AUV 100 to autonomously navigate through the fluid within which the AUV 100 is deployed. Further, the present disclosure describes a few arrangements of components/units of the AUV in FIG. 1, however, it may be appreciated by those skilled in the art that embodiments of the present disclosure may be suitably adapted to have different arrangements of the components/units for the operation of the controller 106. Additionally, the embodiments of the present disclosure may be suitably adapted for applications other than those of the AUV 100, where the CES device/controller 106 is implemented to determine the chemometrics of gases based on the observed spectra and the environmental parameters.

Various components and operations of the controller 106 are described in detail in reference to FIG. 2. Referring to block diagram 200 in FIG. 2, the controller 106 may include one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 may be configured to fetch and execute computer-readable instructions stored in a memory 204. The memory 204 may store the computer-readable instructions or routines, which may be fetched and executed to create or share the data units to other elements of the controller 106. The memory 204 may include any non-transitory storage device including, for example, volatile memory such as Random Access Memory (RAM), or non-volatile memory such as an Erasable Programmable Read-Only Memory (EPROM), flash memory, and the like.

In an embodiment, the controller 106 may also include an interface(s) 206. The interface(s) 206 may include a variety of interfaces, for example, interfaces for data input and output (I/O) devices, referred to as I/O devices, storage devices, and the like. The interface(s) 206 may facilitate communication between the controller 106, and other components of the CES device using peripherals of the controller 106. The interface(s) 206 may also provide a communication pathway for one or more components within the controller 106. Examples of such components include, but are not limited to, processing engine(s) 208 and database 218. The database 218 may also include data that is either stored or generated as a result of functionalities implemented by any of the components of the processing engine(s) 208.

In an embodiment, the processing engine(s) 208 may be implemented as a combination of hardware and software (for example, as programmable instructions) to implement one or more functionalities of the processing engine(s) 208. In examples described herein, such combinations of hardware and software may be implemented in several different ways. For example, the software for the processing engine(s) 208 may be processor-executable instructions stored on a non-transitory machine-readable storage medium and the hardware for the processing engine(s) 208 may include a processing resource (for example, one or more processors), to execute such instructions. In other embodiments, the processing engine(s) 208 may be implemented by electronic circuitry.

In some embodiments, the processing engine(s) 208 may include a control engine 210, a chemometrics engine 212, a correction engine 214, and other engine(s) 216. The other engine(s) 216 may implement functionalities that supplement applications/functions performed by the controller 106.

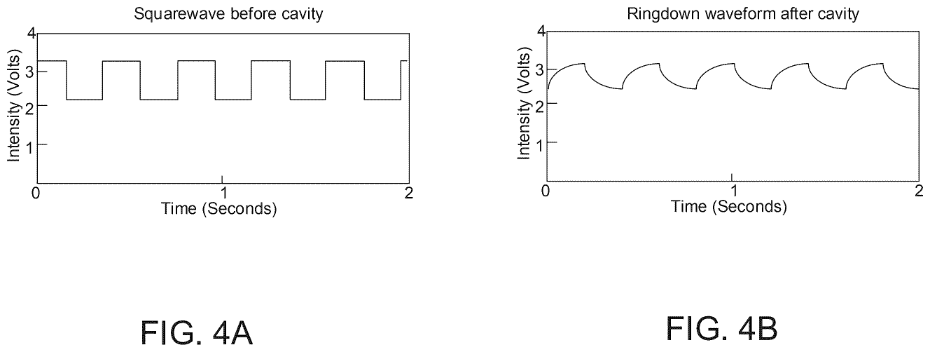

In some embodiments, the control engine 210 may be configured to control operation of the CES device, such as by controlling components thereof. In some embodiments, the control engine 210 may be configured to control the spectral properties of light being injected into the cavity 102. The control engine 210 may modulate the spectral properties of the light by transmitting electrical signals to the laser driver 109. In some embodiments, the waveform of the light may be modulated according to a predictable set of harmonic frequencies, such that the harmonic amplitude of the ringdown signals is also correspondingly modulated. For example, the light may be modulated to have a square waveform, such that the ringdown signals have a clipped or modulated/clipped sinusoidal waveform, as shown in FIGS. 4A and 4B, respectively.

Further, the control engine 210 may be configured to receive the ringdown signals and the environmental parameters (in the form of electrical signals) from the optical detector 110 and the sensors 112A, 112B, and 120 (among others). In some embodiments, the control engine 210 may be configured to aggregate the ringdown signals and/or the environmental parameters thereof (such as based on time-stamps for synchronization), and provide the chemometrics engine 212 with the aggregated ringdown signals and the environmental parameters for determination of chemometrics.

In some embodiments, the chemometrics engine 212 may be configured to determine decay times or decay time constants associated with the gas sample, based on the ringdown signals. In some embodiments, the chemometrics engine 212 may be configured to determine the decay time based on a ratio of peak amplitudes between selected harmonic pairs in frequency domain of the ringdown signals.

In some embodiments, to further improve accuracy of the decay times, multiple ones of the decay time may be combined as a weighted sum based on a signal-to-noise ratio (SNR) of each harmonic in the ringdown signals. The SNR may be determined by comparing the harmonic's amplitude to the noise in adjacent frequency bands.

In some embodiments, the observed spectra may be captured by scanning the injected light one or more times across a band of interest on the target spectral range, and collecting absorption values and/or intensity of light at predefined wavelength intervals. The absorption values per scan may be interlaced and averaged per wavelength over multiple passes. In some embodiments, the chemometrics engine 212 may be configured to preprocess the observed spectra. Prior to determination of the chemometrics, observed spectra may also be smoothed or denoised using techniques such as low pass filtering, windowed averaging, gaussian smoothing, polynomial fitting, spline fitting, or other related methods, but not limited thereto. Denoising may be applied to each scanning pass and/or to an aggregate of multiple scans. The preprocessed observed spectra may also be used by the correction engine 214 for instrument drift correction.

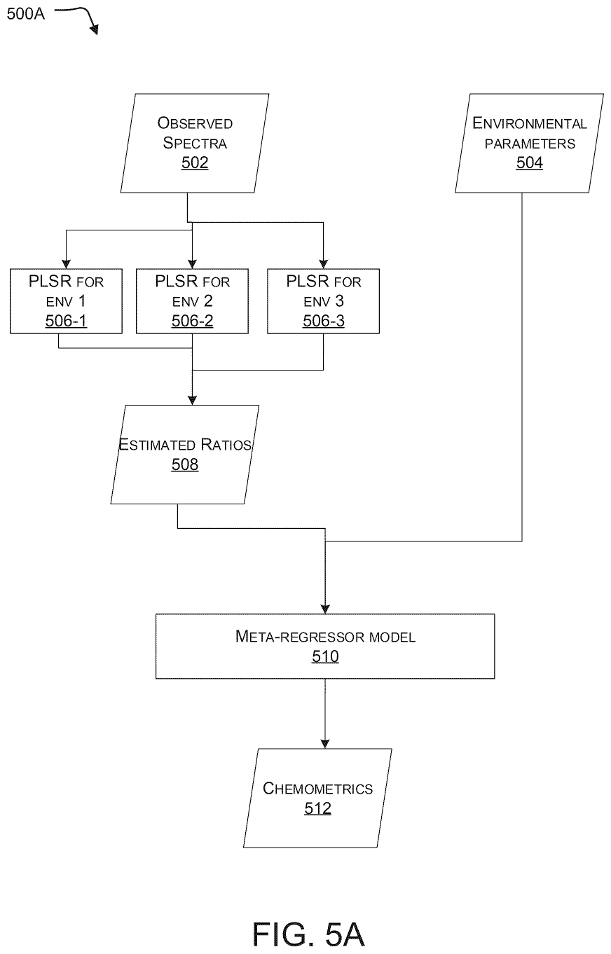

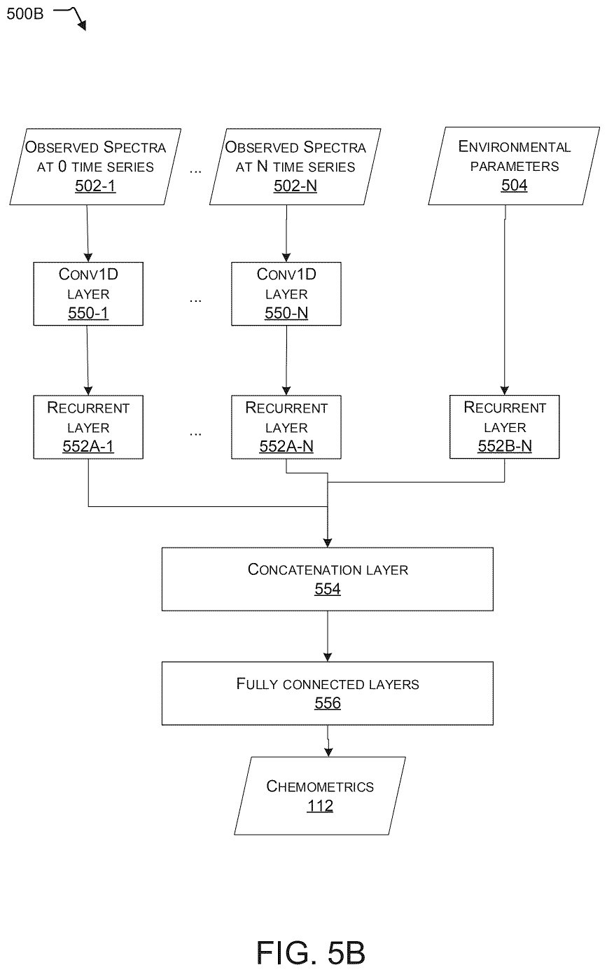

In some embodiments, the chemometrics engine 212 may be configured to use AI models (as shown in FIGS. 5A and 5B), to determine the chemometrics of the gas sample based on the observed spectra (or the decay times extracted therefrom), and the environmental parameters. In some embodiments, the AI models may be locally available within the AUV 100, for real-time in-situ determination of the chemometrics. Since AI models are less computationally complex/intensive in comparison to optimization algorithms (as used by conventional applications), the chemometrics engine 212 may be able to determine the chemometrics of the gas sample in-situ, and in real-time. The chemometrics determined may be stored in the database 218, for further processing/analysis, along with other metadata such as geolocation coordinates, time stamps, and the like.

In other embodiments, the chemometrics may be determined post-survey, i.e., after the AUV 100 has collected the observed spectra for different volumes of fluid, and corresponding environmental parameters associated with the gas sample. The observed spectra and the environmental parameters from the survey may be stored in the database 218. In such embodiments, the AI models may be located in external/remote cloud servers and accessed through application programming interface (API) calls, for example, but not limited thereto. In other embodiments, the AI models may be located in an external computer, for example, on a ship or on land, to which the AUV 100 may be brought after the survey, and from which the data from the database 218 may be retrieved for post-survey chemometrics determination using the AI models. Further details of the AI models for chemometrics detection are provided in reference to FIGS. 5A and 5B.

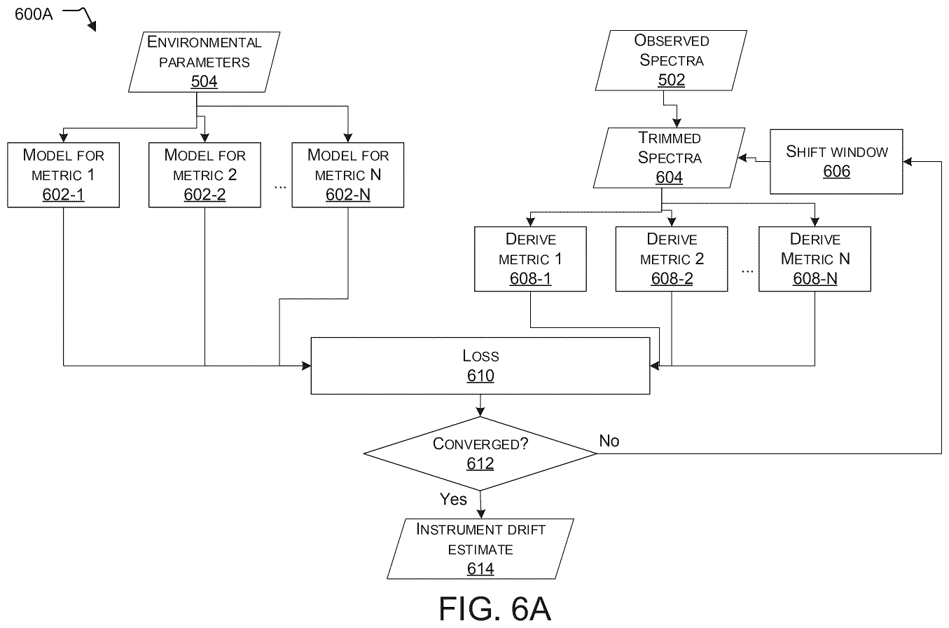

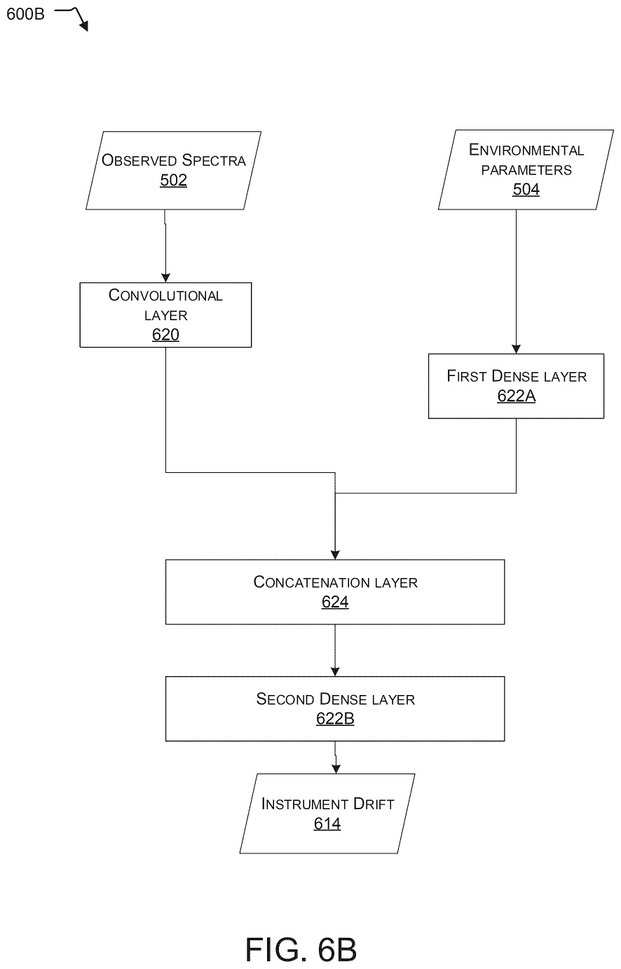

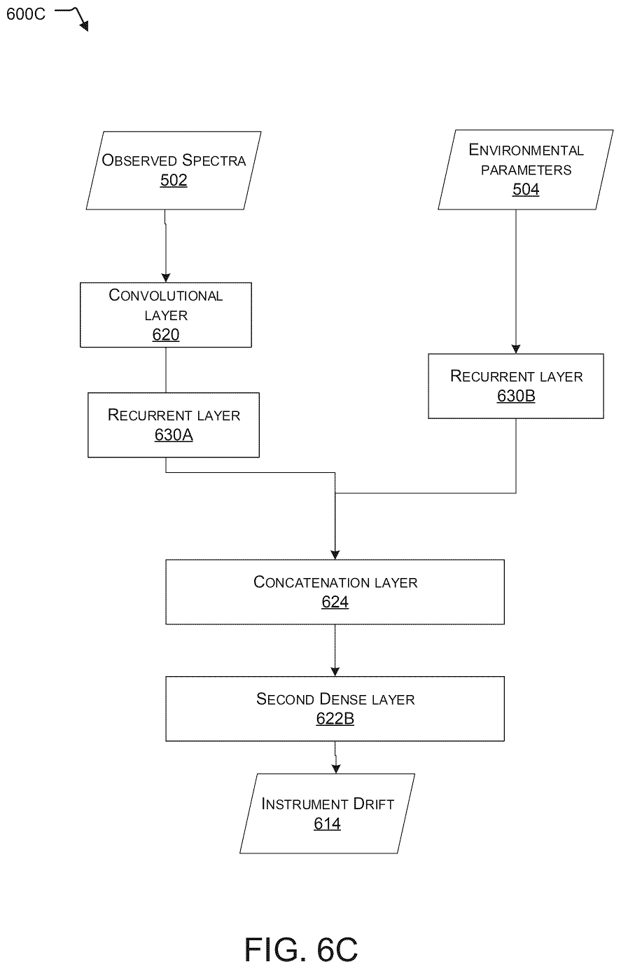

In some embodiments, the correction engine 214 may be configured to correct response times observed during measurement of the environmental parameters and/or the ringdown signals. Further, the correction engine 214 may be configured to determine instrument drift estimates, to account for instrument drifts before determination of the chemometrics. In some embodiments, the correction engine 214 and the control engine 210 may cooperatively determine and correct instrument drifts in CES device. Further details of correction mechanisms are described in reference to FIGS. 6A to 6C in the present disclosure.

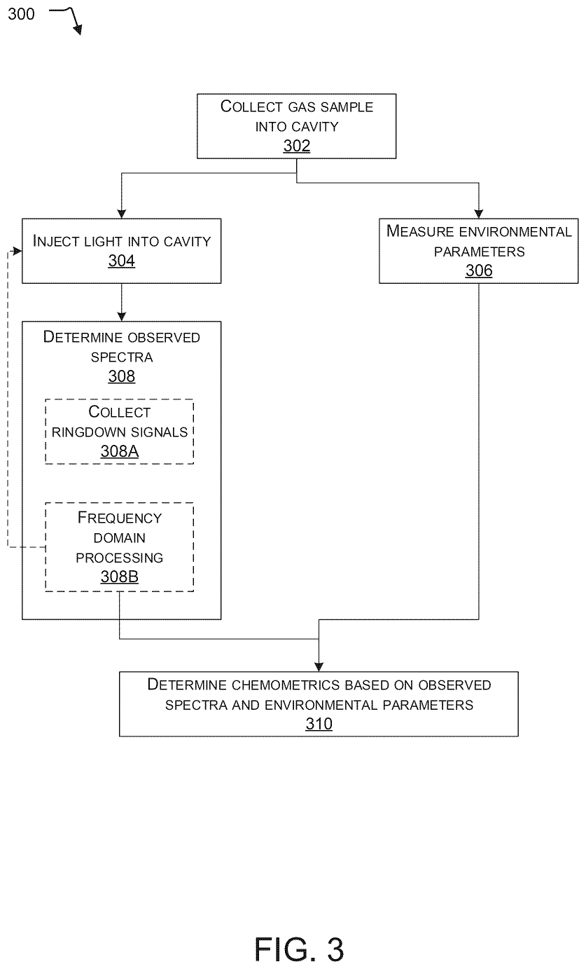

Referring to FIG. 3, a flowchart of an example method 300 of operation of the CES device is shown. The method 300 may be implemented by the controller 106 of the AUV 100.

At step 302, the method 300 includes collecting a gas sample into a cavity (such as the cavity 102) of the CES device. The gas sample may be dissolved gases collected/extracted from a fluid source, such as a water column, through a membrane-based sampler (such as the membrane 122). The membrane 122 may be hydrophobic membrane, which allows the passive diffusion of non-polar molecules (e.g., methane, carbon dioxide) while rejecting polar molecules, like water.

At step 304, the method 300 includes injecting light into the gas sample in the cavity 102, by one or more lasers (such as laser 108) of the CES device, to obtain one or more ringdown signals. The light may be absorbed by the gas sample, based on the molecular composition thereof. In some embodiments, the spectral attributes/properties of the light emitted by the laser 108 may be modulated, such as using the controller 106. The light injected into the cavity 102 may be reflected back-and-forth between the mirrors 104-1, 104-2 of the cavity 102. The spectral properties of the light may be selected/modulated to resonate/constructively interfere with the light being reflected within the cavity 102. In some embodiments, multiple ones of the laser 108 may be used, each being configured to emit light of different spectral property (such as wavelength). The wavelengths of light to be emitted may be selected based on the absorption of the light by the target gases.

Further, in some embodiments, the light may be modulated to determine the decay time. For determining the decay time, the method 300 may include modulating spectral properties of light being injected into the cavity 102 according to a predictable set of harmonic frequencies, such that harmonic amplitudes of the ringdown signals (as generated by the optical detectors 110) are also correspondingly modulated. Thereafter, the method 300 may include determining the decay time based on a ratio of peak amplitudes between selected harmonic pairs in frequency domain of the ringdown signals.

As stated, existing solutions often use optimization algorithms, such as Levenberg-Marquardt (LM) method for determining decay time constant of the gas sample, which are computationally expensive. Such methods are not well-suited for real-time analysis in low-power or resource-constrained contexts, due to their significant computational requirements.

To reduce computational expenditure, in some embodiments, the method 300 may include determining multiple ones of the decay time based on multiple successive ringdown signals from the ringdown signals. In such embodiments, the method 300 may include analyzing, by the controller 106, multiple successive ringdowns as a single waveform in the frequency domain. The decay times may then be used for the determination of chemometrics, thereby eliminating the need for computationally intensive time-domain fitting.

At step 306, the method 300 includes determining an observed spectra for the gas sample based on absorption of the injected light. As stated, the absorption of the light by the gas sample may be detected by the optical detector 110 of the CES device. The step 306 may include sub-step 306A where the ringdown signals are collected from the optical detector 110, and sub-step 306B where the ringdown signals may be processed in the frequency domain. The sub-steps 306A and 306B may be iterated until all frequencies have been extracted.

For example, the light may be modulated (as described in step 304) to have a square waveform, as shown in FIG. 4A. As a result, the ringdown signal may have a waveform as shown in FIG. 4B, as collected by the optical detector 110. Using a square waveform for the light may generate a predictable set of harmonic frequencies (e.g. the fundamental frequency of a square wave and its odd multiples, such as f, 3f, 5f, etc.). The exponential decay of the ringdown signal modulates the harmonic amplitudes, with the decay time constant governing the progressive attenuation of higher harmonics relative to lower ones. This relationship allows the decay time constant to be extracted by analyzing the amplitude ratios of selected harmonics.

Further, transmitted time domain signal from the optical detector 110 may be transformed into the frequency domain using Fourier transform methods (FFT), revealing distinct peaks at these harmonic frequencies. In some embodiments, the decay constant of the original ringdown waveform may be calculated by analyzing the ratio of the amplitudes at selected harmonic pairs, such as f and 3f.

While the aforementioned embodiment/example is described in the context of the light being modulated to have a square waveform, it may be appreciated that other waveforms may also be used in other embodiments.

In some embodiments, the multiple ones of the decay time are combined as a weighted sum based on a SNR of each harmonic in the ringdown signals, to further improve accuracy. In some embodiments, the SNR may be determined by comparing each harmonic's amplitude to noise in adjacent frequency bands. This ensures that harmonics with higher reliability contribute more heavily to the final result, compensating for the attenuation and increased noise often observed in higher harmonics.

Modulating the waveform of the light, and/or determining the decay time based on multiple successive ringdown signals may reduce processing time by 1-2 orders of magnitude while maintaining high accuracy, making it ideal for real-time applications where computational resources are scarce, such as in remote sensing, environmental monitoring, or other scenarios where speed, efficiency, and precision are critical.

At step 308 the method 300 may include collecting/measuring the environmental parameters, such as the (internal and external) temperatures, and pressure associated with the CES device. The environmental parameters may be measured by the sensors 112A, 112B, and 120. The environmental parameters may be collected in real-time/parallelly, as the ringdown signals are generated. Further, the environmental parameters and the ringdown signals may be synchronized (such as using time stamps thereof, or real-time correction techniques), for determination of the chemometrics.

In some embodiments, the method 300 may also include correcting the observed spectra and the environmental parameters for response time errors (to compensate for inherent time delays in measurement processes), and/or instrument drift errors. Such corrections may be implemented before the chemometrics are determined at step 310, to improve accuracy of the determinations. Further details of the method 300 are provided subsequently in the present disclosure.

At step 310, the method 300 includes determining chemometrics of the gas sample by processing, via AI models, the observed spectra and/or environmental parameters of the gas sample. In some embodiments, the decay time constants associated with the observed spectra may be extracted, and provided as input to the AI models along with the environmental parameters. The AI models may be adapted to determine the chemometrics, such as molecular (and/or isotropic ratios), and concentration of gases of the gas samples.

As stated, the observed spectra may be analyzed to determine the concentration and relative abundance of constituent gases in the gas sample. In infrared (IR) range, absorption at a given wavelength typically scales linearly with concentration, provided temperature and pressure remain constant. However, variations in temperature, pressure, and other environmental factors can significantly alter absorption profiles, and spectral/absorption line overlap is a frequent challenge, which may be particularly pronounced when analyzing isotopologues (or pair thereof), as their spectra often differ only slightly, such as due to doppler or collision broadening. Consequently, accurately quantifying individual species' concentrations requires careful handling of overlapping features and environmental variations. Existing solutions use computationally intensive methods, such as least-squares optimization algorithms to minimize error of a linear equation based on the observed spectra (or decay time constants derived therefrom), where each variable corresponds to a gas and each coefficient corresponds to a quantity of the gas. Despite their accuracy, these spectral fitting techniques are computationally demanding due to the need to generate physically realistic spectral profiles and perform multivariate optimization. These requirements make them impractical for real-time applications, particularly on low-power, in situ devices with limited computational resources. The present disclosure avoids this problem by adapting AI models for determining the chemometrics based on the observed spectra and the environmental variables.

The method 300 and the controller 106 of the present disclosure account for such changes in the environment by adapting AI models to take the observed spectra and the environmental parameters as inputs to generate the chemometrics. Such adaptations may allow for accurate estimation of molecular ratios in variable and extreme environments. The AI models effectively provide dynamic ratio calibration by learning how environmental information impacts baseline spectral behaviors. In some embodiments, instrument drift errors may be corrected before the AI models process the observed spectra and the environmental parameters, as described subsequently in reference to FIGS. 6A to 6C. In some embodiments, the observed spectra and the environmental parameters input to the AI models may be preprocessed, and/or instrument drift corrected and response-time corrected.

In some embodiments, a single AI model may be provided with structured inputs for chemometrics determination. In other embodiments, the chemometrics may be determined using an ensemble model estimation, having one model for each possible environmental condition. In further embodiments, a multimodal hybrid neural network/model may be used for chemometrics determination. Any combination of the aforementioned models may also be used for determination of the chemometrics.

In embodiments where a single AI model is used, the AI model may be trained to output a single scalar value representing the molecular ratio of the gas sample, given structured (the observed) spectra and the environmental parameters as inputs. In some embodiments, the observed spectra may include/indicate absorption values from wavelengths associated with at least 2 species (i.e., characteristic wavelengths having at least one absorption 9 line on the observed spectra for each species). Further, the environmental parameters may be associated with the analyte (i.e., the gas sample), such as the temperature and the pressure of the gas sample within the cavity 102.

Absorption values may represent the total absorption across bands of arbitrary spectral width, which may be captured as a single absorption value using the laser 108 of a given/predefined/known line width, or by integrating area under curve (AUC) of multiple adjacent measurements about the targeted feature.

The AI model may receive at least the following observed or derived values as input, viz., 1) ratio of absorption values for a first species and a second species/molecules, 2) absolute absorption value for one of the target species/molecules, 3) analyte temperature (if not stabilized), 4) analyte pressure (if not stabilized), and the like. Using inputs 2-4, the AI model learns to dynamically calibrate the relationship between absorption ratio and molecular ratio under given conditions. Jointly modeled environmental parameters, such as temperature and pressure, may capture general variations (i.e., in absorption line widths) due to factors such as doppler and collisional broadening. The relationship between inputs 2-4 also may also allow fine-tuning of the estimates of molecular ratios by capturing the extent to which the spectrum is influenced by the target species versus other ambient gases, which may differently affect the impacts of factors such as collisional broadening. The absorption of lines related to gases other than the target species (or other representations of those species' quantities) may also be included to model/define (collisional) broadening and related phenomena with more granularity.

In some embodiments, the AI model may be implemented as a Generalized Additive Models (GAMs), which may provide structured smooth terms and tensor interactions for capturing nonlinear relationships between features. In such embodiments, smooth P-spline terms may be used to capture the individual relationships between measured absorption ratio, temperature, and pressure, and the target molecular ratio. Further, tensor smooth terms may be used to capture the joint effects of temperature with pressure, as well as the joint effects of a single absorption value, temperature, and pressure. Additionally, hyperparameters such as number of splines or lambda may be tuned based on noise levels and data complexity.

In other embodiments, the AI model may be tree-based models such as including, but not limited to, Random Forest, XGBoost, LightGBM, or the like, but not limited thereto. In further embodiments, the AI model may be a kernel-based model, such as support vector machines (SVMs) with nonlinear kernels to model complex relationships, but not limited thereto. In some embodiments, the AI model may be a neural network configured to learn non-linear combinations between the inputs, i.e., the observed spectra and the environmental parameters. In some embodiments, the AI models may be trained on datasets having the inputs 1-4. The datasets may be developed through empirical data, and/or synthetic data.

In some embodiments, predictions/estimates/outputs from multiple AI models may be combined using a secondary meta-regressor that refines the instrument drift estimate (as described subsequently in the present disclosure). Examples of secondary models include, tree-based models, neural networks (such as simple feed-forward network to learn non-linear combinations of primary model outputs), and/or regression models (that use weighted linear regression to dynamically combine predictions based on reliability), but not limited thereto.

Referring to FIG. 5A, an example architecture 500A of an ensemble AI model for chemometric determination is shown. The architecture 500A corresponds to an ensemble model, having separate models to process observed spectra 502 for each possible/expected environmental condition. The architecture 500A includes a meta-regressor model 510 (i.e., the AI model) configured to receive the environmental parameters as inputs. The meta-regressor model 510 may also receive the observed spectra 502 processed through one or more of partial least-squares regression (PLSR) models 506-1 to 506-3 (collectively referred to as PLSR model 506) as inputs. The PLSR models 506 may be trained to estimate the quantities of both species under specific environmental conditions. Each PLSR model 506 may use the full normalized spectrum or a subset of the captured spectra, as long as at least one spectral line per species is included. The PLSR models 506 may be trained on datasets collected at intervals that adequately cover the entire range of environmental conditions. The PLSR model 506 may be configured to determine calculated/estimated molecular ratios 508 from collinear inputs.

Estimated/calculated absorption ratios 508 from all PLSR models 506 may be input into the meta-regression model 510, along with observed environmental parameters 504, in order to regress both species/isotropic concentrations under those environmental conditions. The architecture 500A having ensemble of PLSR models 506 allows the meta-regressor model 510 to account for nonlinear behaviors as well, in the context of anchor estimates for multiple reference environments. The meta-regressor model 510 may output consolidated chemometrics 512 being measured. In some embodiments, the meta-regressor 510 may be implemented as tree-based models (e.g., XGBoost, LightGBM, Random Forests), support vector regression (SVR), elastic net regression (or LASSO/Ridge) and the like.

Referring to FIG. 5B, another example architecture 500B of a neural network implementation of the AI model (i.e., a hybrid model) is shown. As shown, the architecture 500B of the AI model may include one or more convolutional layers 550-1 to 550-N (collectively referred to as convolutional layers 550). In some embodiments, the convolutional layers 550 may be one-dimensional convolutional layers. Each convolutional layer 550 may be configured to receive observed spectra (502-1 to 502-N) at a corresponding time series or time step. The convolutional layers 550 may also include or be replaced by pooling layers and/or flattening layers to change dimensions of the observed spectra 502 provided as input thereto. In some embodiments, the convolutional layers 550 may be configured to receive normalized and/or instrument drift corrected observed spectra 502. Having convolutional layers 550 for each time series may allow non-continuous spectral bands in the observed spectra 502 to be processed.

Optionally, the architecture 500B may include one or more recurrent layers 552A-1 to 552A-N, 552B (collectively referred to as recurrent layers 552). The recurrent layers 552 may be included to account for temporal aspects of the observed spectra. Each of the recurrent layers 552A-1 to 552A-N may be configured to receive outputs from corresponding convolutional layers 550-1 to 550-N, as inputs. The recurrent layer 552B may be configured to receive the environmental parameters 504 as inputs. In some embodiments, the recurrent layers may be implemented as recurrent neural networks, long short-term memory (LSTM) models, and/or gated recurrent units (GRUs), but not limited thereto.

The recurrent layers 552 may provide their outputs to a concatenation layer 554, which combines the outputs and provides the combined output to a dense layer or a fully-connected layer 556 for processing. The fully-connected layer 556 may include one or more sets of densely connected neurons, configured to process the combined outputs of the recurrent layers 552. The fully-connected layer 556 may output the chemometrics 512 for the gas sample. The chemometrics 512 output may be a single scalar value.

In some embodiments, the AI models (regardless of the architecture used) may be trained on a combination of real-spectra collected under controlled laboratory conditions, and/or synthetic spectra generated using high-resolution spectral databases, such as high-resolution transmission molecular absorption database (HITRAN). The training data may span a broad range of isotopic ratios, gas mixtures, temperatures, pressures, and noise levels to ensure robust generalization to real-world conditions. The AI models may be configured to take the observed spectra 502, and the environmental parameters 504 such as temperature and pressure (captured via the sensors 112A, and 112B) as model inputs to account for their influence on absorption profiles, for determining the chemometrics.

The computational complexity of such AI models is dependent on size or hyperparameters of the AI model, such as number of neurons and number of weights therebetween, which may be orders of magnitude lower than those of optimization algorithms. Hence, the use of such AI models may allow for in-situ and real-time determination of the chemometrics, due to their comparatively lower computational demands. In some embodiments, specialized integrated circuits or chips may be designed for execution of the AI models within vehicles/apparatuses within which the AI models may be deployed.

As stated, the inputs (i.e., the observed spectra and the environmental inputs) provided to the AI models may be normalized, and/or corrected for errors. In some embodiments, the inputs may be corrected for instrument drift errors. In CES devices, the lasers 108 have to be precisely tuned to specific wavelengths to make accurate chemometric measurements. Over time, the laser tuning/alignment/calibration may drift due to aging, thermal stresses, electrical stresses, mechanical stresses, and other anomalies, but not limited thereto.

In some embodiments, the instrument drift corrections may be made using other AI models or machine learning (ML) models (which may be accessible by the controller 106). In some embodiments, the ML models may be trained/configured to quantify instrument drift in variable environmental conditions, using the observed spectra and the environmental parameters as inputs. The ML models may use environmental parameters to build a normative expectation of spectral features against, which the observed spectra may be compared for instrument drift correction.

In some embodiments, instrument drift errors/estimates (or quantifications of the instrument drifts) may be integrated into a control routine. For example, laser temperature may be managed based on the instrument drift estimates, which may be used to dynamically control the target temperature of the laser 108.

In some embodiments, the control routine may include a cascaded control framework. In some embodiments, a two-loop control mechanism may be used to manage drift correction, and for stabilization, independently. The two-loop control mechanism may include an outer loop and an inner loop.

In the outer loop, instrument drift estimate may be determined by the ML model. The instrument drift estimate (represented as d_{ML}) may be used to update a target parameter (T_{target}), which may be any adjustable parameter of the CES instruments, such as power consumption, resolution, spectral attributes, temperature (such as through use of thermoelectric coolers), and the like. The target parameter (T_{target}) may be updated using a calibration constant (k) and an optional weight (w), as shown below:

$${T}_{target , new} = {T}_{target , old} + w \cdot \begin{matrix}{d}_{M L} \\ k\end{matrix}$$

In the inner loop, Proportional-Integral-Derivative (PID) controller (not shown), or the controller 106, may control the CES device (or the laser 108) based on T_{target,new}. In some embodiments, to ensure corrections are applied appropriately, the outer loop may optionally operate in a stability-dependent correction mode, or a weighted correction mode. In the stability-dependent correction mode, the T_{target,new} may be adjusted when the inner loop is stable, i.e., when the difference between the target parameter measured and the previous measurement of the target parameter is less than a predefined threshold (E), i.e., defined by:

\T_{measured}−T_{target,old}\<E

In the weighted corrections mode, the target parameter may be adjusted based on the instrument drift estimate scaled by a weight based on the stability of the target parameter (which may be determined based on ratio between a maximum difference value, and the difference between the currently measured and previously measured target parameter), defined by:

$$w = 1 - \begin{matrix}∖ {T}_{measured} - {T}_{target , old} ∖ \\ {LIT}_{max}\end{matrix}$$

In such embodiments, the weight reduces the influence of drift corrections when the CED device is unstable.

Various embodiments of the ML models used for the instrument drift estimation are described in reference to FIGS. 6A to 6C. In some embodiments, prior to analysis, the observed spectra may be smoothed or denoised using techniques such as low pass filtering, windowed averaging, gaussian smoothing, polynomial fitting, spline fitting, or other related methods.

In some embodiments, an architecture of the ML model may include comparing one or more spectral metrics derived from the observed spectra, to values predicted therefor by a corresponding regression model. In other embodiments, the architecture of the ML model may be that of an ensemble model that operates on structured inputs. In other embodiments, the architecture of the ML model indicative of a multimodal hybrid neural network/model.

Referring to FIG. 6A, an example architecture 600A of the ML model is shown. As shown, instrument drift estimate 614 may be determined by comparing one or more of the spectral metrics (such as metric 1 to metric N) derived from the observed spectra 502, to corresponding values therefor predicted by a respective pretrained models/regression model (such as models 602-1 to 602-N, collectively referred to as regression models 602). Each of the regression models 602 may be trained to predict a single spectral metric for a stabilized wavelength band (i.e., where there is no instrument drift) based on the environmental parameters, such as temperature, pressure, and humidity. The predicted values from the regression models 602 may be compared with corresponding derived values of the metrics 608-1 to 608-N, the difference therebetween being represented as loss 610. In such embodiments, it is assumed that the observed spectra 502 remain structurally valid, but may be shifted to an unknown extent along the wavelength axis due to the instrument drift.

In some embodiments, the spectral metrics used for the comparison may include any one or a combination of, positions of maxima and minima, mean wavelength of absorption peaks, and/or standard deviation of peak wavelengths, but are not limited thereto. The positions of maxima and minima may refer to locations of global or local extrema within the scanned wavelength range. The mean wavelength of absorption peaks represents the weighted mean position of absorption peaks, where the weights correspond to the intensities of the peaks. The standard deviation of peak wavelengths quantifies the spread of peak positions along the wavelength axis, indicating how dispersed or clustered the peaks are. The instrument drift may alter or distort the aforementioned spectral metrics.

In some embodiments, ratios or differences, skewness, and derivative-based features, but are not limited thereto, may also be used as spectral metrics for comparison. In some embodiments, the ratios or differences may be determined using absorption values from fixed locations, dynamically determined locations, or a combination of both. Fixed locations refer to ratios derived from absorption values at predetermined positions within the scanned range (e.g., 10% from the lower and upper bounds of the band). Dynamically determined locations involve ratios based on absorption values identified in real time, such as the wavelengths corresponding to the global minimum or maximum intensity. A combination of fixed and dynamic locations allows for ratios that mix values from both categories, capturing relative spectral changes while reducing sensitivity to overall intensity variations.

Further, skewness and asymmetry may serve as measures of spectral asymmetry. The instrument drift in the observed spectra may result in asymmetric shifts, where features move unequally, making skewness a valuable indirect indicator of instrument drift estimation.

In some embodiments, the regression models 602 may be configured to determine/predict the spectral metrics in optimal conditions (i.e., in conditions without instrument drift) based on the environmental parameters. Separate regression models 602 may be trained and deployed for each of the spectral metrics. In some embodiments, the regression models may be any one or a combination of, GAMs, tree-based models, and/or kernel-based models. In an example, the GAMs (implementing the regression models 602) may model the spectral metrics as a function of the environmental parameters. In such examples, tensor smooth terms of the GAM may capture interrelated nonlinear behaviors between variables such as temperature and pressure. Further, univariate smooth terms of the GAM may define individual relationships between spectral metrics and environmental parameters. Additionally, spline parameters, such as the number of splines and regularization terms (λ), may be tuned to balance model complexity and overfitting.

In some embodiments, additional spectral statistics that vary with concentration, such as the maximum absorption value of the spectrum, may be included as supplementary inputs to improve predictive accuracy. Such features capture secondary effects, such as differing broadening behaviors between the target and other gases, that may influence spectral metrics.

In some embodiments, the instrument drift estimate 614 may be determined by translating the observed spectra along the wavelength axis, such that the loss 610 between the predicted metrics and the corresponding derived metrics 608 are minimized. In some embodiments, least-squares optimization methods may be used to minimize the loss 610.

In some embodiments, during each iteration of the least-squares optimization methods, the observed spectrum 502 may be dynamically trimmed (into trimmed spectra 604) based on input constraints of each regression model 602. To accommodate the iterative shifting, the observed spectrum must include a broader wavelength range than was used to train the regression models 602 (or the input constraints thereof). In some embodiments, a shift window indicative of an interval may be defined/used for trimming the observed spectra. The 12 instrument's estimated drift is calculated as the shift of the observed spectra 502 upon convergence.

As stated, the regression models 602 may be trained to determine the predicted metrics based on the environmental parameters. Parameters of the regression models 602 may be adjusted/optimized using weighted least-squares optimization methods, where the weights may be inversely proportional to squared confidence intervals or other prediction reliability metric of the regression model 602 in use. Such methods may prioritize metrics with higher reliability under given environmental conditions, and reduce the influence of less certain predictions. Prior to optimization, each metric may be normalized using techniques such as min-max scaling, z-score normalization, or similar.

The weighted cost function is defined as:

$$! o st = {\%}_{i = 1}^{N} {w}_{i} \cdot {( + , ser / {ed}_{1} - 0 r edi 2 {ted}_{i} )}^{2}$$

where

$${w}_{1} = \frac{1}{i} ,$$

and crᵢ is the confidence interval (or similar metric) of the i^{th} metric, and metric inputs have been normalized. Convergence (at 612) may be achieved when changes in the drift shift or the weighted cost function fall below calibrated thresholds.

In some embodiments, for translations smaller than a spectral resolution (which may be predefined/pre-selected), techniques such as linear interpolation or spline interpolation may be applied to smoothly estimate intermediate spectral values.

In other embodiments, the architecture of the ML models may be adapted for direct instrument drift estimation. In such embodiments, the ML models may be trained/adapted to receive the observed spectra 502 and the environmental parameters 504 as inputs, and generate the instrument drift estimates 614 as output, thereby generating instrument drift estimations without iterative fitting. Such ML models may be configured to model non-linear interactions between the inputs provided thereto. In such embodiments, the ML models may be implemented as any one or a combination of, GAMs, tree-based models, SVMs, neural networks, Gaussian process regression (which Radial Basis Function (RBF) or similar kernels), and the like, but not limited thereto.

In examples where the ML model is implemented as or includes GAMs, spectral metrics may be incorporated into the GAM through separate smooth terms (e.g., P-splines) for each of the inputs, and tensor smooth terms for interactions between the inputs. In some embodiments, the ML model may be configured to capture both individual contributions and combined effects of the spectral metrics under varying environmental conditions. For example, the spectral metrics max absorption location and edge absorption ratio may be combined in a tensor smooth term to account for non-linear interactions therebetween.

In some embodiments, either a signal model may be trained, or an ensemble of models may be trained to determine the instrument drift estimates 614, based on the observed spectra 502 and the environmental parameters 504. In embodiments where the architecture includes an ensemble of models, each of the models may be trained for each individual spectral metric or subsets of metrics. In such embodiments, the instrument drift may then be calculated as a weighted average of predictions, where weights are inversely proportional to the squared confidence intervals or other prediction reliability metric. The drift estimated may be defined by:

$$Drift Estimate = {{\sum }^{N}}^{} {w}_{1} \cdot {Model}_{i} ( inputs ) , and \\ \text{?}$$

$${w}_{i} = {\sum }_{j = 1}^{N} \text{?}$$

$$\text{?} \text{indicates text missing or illegible when filed}$$

where
N is the number of individual models used in the ensemble,
wᵢ is the weight for the i^{th} model, based on the confidence interval or reliability of its prediction,
Modelᵢ (inputs) is the prediction from the i^{th} model, which uses spectral metrics and environmental inputs to estimate drift, and
cr² is variance or other prediction reliability metric of the i^{th} model's prediction.

In some embodiments, the predicted metrics/values from multiple models may be combined using a secondary meta-regressor model that refines the instrument drift estimate. Examples of secondary models may include tree-based models, neural networks, regression models, and the like, but not limited thereto.

In further embodiments, the ML models used for instrument drift estimation may be multi-modal neural networks. FIGS. 6B and 6C show example architectures 600B and 600C of the neural networks configured to estimate the instrument drift. In such embodiments, the neural networks may be configured to automatically determine the spectral metrics, thereby eliminating the need for separately deriving the spectral metrics from the observed spectra 502. The neural networks may use both the environmental parameters and the observed spectra 502 for instrument drift estimations.

Referring to FIG. 6B, the architecture 600B of the neural network may include a (pooling/flattening)/convolutional layer 620 to process the observed spectra 502. The convolutional layer 620 may be configured to convolve the observed spectra 502, and thereby adjust the dimensions of the observed spectra 502. In some embodiments, each spectrum in the observed spectra 502 may be independently normalized. Optionally, another layer may be appended to the convolutional layer to derive spectral metrics from the convolved observed spectra, such as peak intensity and/or integrated areas. The neural network may also include a first dense layer 622A configured to receive the environmental parameters 504. In some embodiments, the environmental parameters 504 may be globally normalized. The outputs of the convolution layer 620 and the first dense layer 622A may be concatenated at a concatenation layer 624. The output of the concatenation layer may be provided to a second dense layer 622B, which may be configured to determine the instrument drift estimates 614.

In some embodiments, additional layers may be incorporated into the neural network shown in FIG. 6B, to account for temporal aspects of the observed spectra 502 and the environmental parameters 504.

Referring to FIG. 6C, an architecture 600C of the ML model/neural network for instrument drift estimation is shown. The architecture 600C, in addition to the layers of the architecture 600C, may include one or more recurrent layers, such as the recurrent layers 630A and 630B. The recurrent layers 630A and 630B may be configured to receive the convolved observed spectra and the environmental parameters 504 as inputs. In such embodiments, the observed spectra 502 and the environmental parameters 504 may be provided as time-series inputs (i.e., values over a period of time). The outputs of the recurrent layers 630A and 630B may be concatenated by the concatenation layer 624, the concentrated output being used by the second dense layer 622B to determine the instrument drift estimates 614.

The recurrent layers 630A, 630B may be included to address scenarios where instrument drift evolves over time. The use of the recurrent layers 630A, 630B may account for temporal dependencies for determining the instrument drift estimates 614, while the convolutional layer 620 (and other layers such as the dense layer, if added) may account for spatial dependencies, of both the observed spectra 502 and the environmental parameters 504. The temporal dependencies may be modeled across multiple time steps. The architecture 600C, hence, may leverage sequential modeling techniques to capture dynamic patterns in both spectral and environmental inputs.

Once the instrument drift corrections are made, response-time corrections may also be performed during/before inference.

The CES device relies on passive gas diffusion across the membranes 122 to sample analytes/gas samples from the fluid. The diffusion process may be governed by diffusion kinetics, which inherently delays the sensor response, causing measured time-series concentrations to lag behind real-time ambient environmental conditions. Such time delays often result in a smoothing of rapid concentration changes, with the sensor output resembling a moving average of the true ambient values. Slow diffusion kinetics may affect accuracy and responsiveness of the measurements, which may be undesirable particularly in dynamic environments where rapid variations in analyte concentrations are critical to capture (such as when the AUV 100 is moving through a region of seawater for energy exploration).

To address response delays, conventional systems optimize membrane properties and employ both physical and computational mitigation strategies. Some physical strategies include use of pumps on wet-side of the membrane 122 of the CES device, to actively circulate fluid and maintain representative gas gradients by preventing localized depletion or enrichment near the membrane surface. Additionally, or alternatively, vacuum pumps or carrier gases may be used to enhance the pressure gradient across the membrane, accelerating diffusion into the measurement chamber. While such solutions may improve response times, they are power-intensive, and bulky hardware that limits their practicality for long-term, low-power deployments in remote or autonomous applications. Meanwhile, conventional computational solutions aim to reconstruct the true ambient concentration from smoothed sensor signals using deconvolution techniques. Such solutions rely on diffusion models that “unwind” lag. Further, deconvolution techniques leverage domain-specific assumptions to constrain uncertainty and improve signal recovery. Solutions that use iterative algorithms may balance noise suppression with the preservation of temporal resolution, but such solutions often amplify measurement noise and require careful tuning of regularization parameters, thereby introducing challenges for reliable uncertainty quantification and model robustness in varying environments.

To overcome these limitations, the controller 106 and the method 300 may include forecasting real-time ambient gas concentrations in the volume of fluid. In some embodiments, time-series forecasting models may be trained to predict ambient concentrations using diverse environmental telemetry (such as ambient and internal temperature, depth-associated pressure, depth/hydrostatic pressure, salinity, and the like, but not limited thereto) and the observed spectra 502 as input features. The forecasting model may be trained to identify diffusion behaviors from empirical data, capturing both expected behaviors represented by conventional first-principles models, as well as unexpected or idiosyncratic behaviors of the CES device. In some embodiments, the forecasting model may be implemented as a type of AI/ML model, which demands less computational resources in comparison to iterative fitting techniques.

Furthermore, in some embodiments, natural or induced motion of the CES device/AUV 100 may be used to improve diffusion rates. For example, the membrane 122 of the CES device may be pushed against the volume of the fluid (or column of water) to increase pressure, which in-turn increases the diffusion rates between the fluid and the CES device through the membrane 122.

Hence, the present disclosure provides a method and an AUV for chemometric determination of dissolved gases in fluid (such as water) using the CES device addresses several technical challenges. The use of modulated spectral properties of injected light and frequency domain analysis of ringdown signals reduces the computational burden associated with decay time constant estimation, enabling real-time analysis. For determination of the chemometrics, AI models may be used to process observed spectra and environmental parameters, thereby circumventing the computationally intensive iterative spectral fitting methods, and facilitating rapid in-situ determination of molecular compositions/concentrations. Furthermore, to maintain accuracy over time, a cascade control framework incorporating ML-based drift estimation dynamically adjusts laser temperature (among other parameters) to correct for instrument drift. Additionally, to minimize response time delays inherent in membrane-based sensors, time series forecasting models may be used to predict ambient gas, allowing for accurate measurements even in dynamic environments without relying on power-intensive pumps.

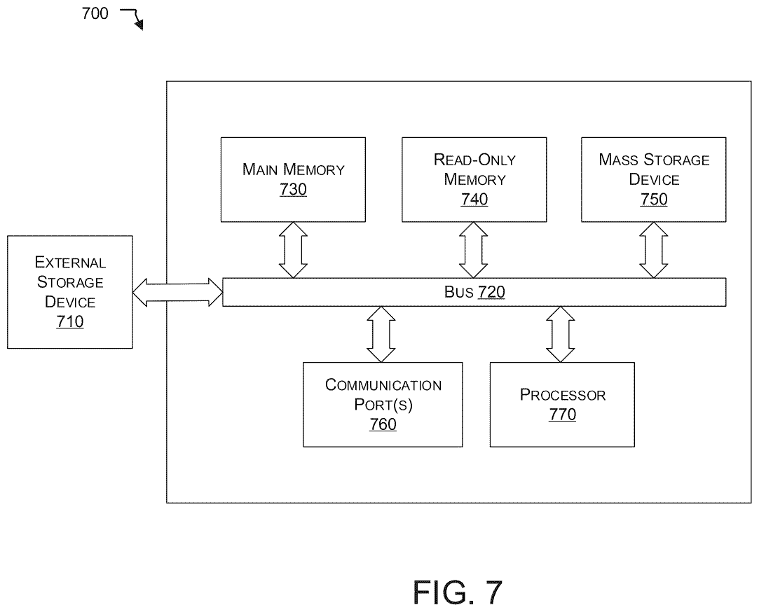

The controller 106/AUV 100 and the method 300 described above may be implemented on a computer system. Referring to FIG. 7, the block diagram represents a computer system 700 that includes an external storage device 710, a bus 720, a main memory 730, a read only memory 740, a mass storage device 750, a communication port 760, and a processor 770. A person skilled in the art will appreciate that the computer system 700 may include more than one processor 770 and communication ports 760. The processor 770 may include various modules associated with embodiments of the present disclosure. The communication port 760 can be any of a Recommended Standard 232 port for use with a modem-based dialup connection, a 10/100 Ethernet port, a Gigabit or 10 Gigabit port using copper or fiber, a serial port, a parallel port, or other existing or future ports. The communication port 760 may be chosen depending on a network, such as a Local Area Network (LAN), a Wide Area Network (WAN), or any network to which computer system 700 connects.

In an embodiment, the memory 730 can be a RAM, or any other dynamic storage device commonly known in the art. The Read-Only Memory (ROM) 740 may be any static storage device(s) e.g., but not limited to, a Programmable Read-Only Memory (PROM) chip for storing static information. The mass storage 760 may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus 720 communicatively couples the processor(s) 770 with the other memory, storage, and communication blocks. The bus 720 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor to the computer system 700.

In another embodiment, operator, and administrative interfaces, e.g., a display, keyboard, and a cursor control device, may also be coupled to the bus 720 to support direct operator interaction with computer system 700. Other operator and administrative interfaces may be provided through network connections connected through communication port 760. In some embodiments, the external storage device 710 can be any kind of external hard-drives, floppy drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 700 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

What is claimed is:

1. A method for determining chemometrics of dissolved gases in a fluid using a cavity-enhanced spectroscopy (CES) device, comprising:
collecting a gas sample into a cavity of the CES device;
injecting light into the gas sample in the cavity, by one or more lasers of the CES device, to obtain one or more ringdown signals;
determining an observed spectra for the gas sample based on absorption of the injected light indicated by the one or more ringdown signals; and
determining chemometrics of the gas sample by processing, via an artificial intelligence (AI) model, the observed spectra and/or environmental parameters of the gas sample.

2. The method of claim 1, wherein the determined chemometrics comprise at least one of:
molecular ratios and/or concentration of gases.

3. The method of claim 1, the method further comprises:
modulating spectral properties of light being injected into the cavity according to a predictable set of harmonic frequencies such that harmonic amplitudes of the one or more ringdown signals are modulated; and
determining a decay time from the observed spectra based on a ratio of peak amplitudes between at least one selected harmonic pairs in frequency domain of the one or more ringdown signals.

4. The method of claim 3, wherein the light is modulated to a square wave.

5. The method of claim 3, wherein the method further comprises determining multiple ones of the decay time based on multiple successive ringdown signals from the one or more ringdown signals.

6. The method of claim 5, wherein the multiple ones of the decay time are combined as a weighted sum based on a signal-to-noise ratio (SNR) of each harmonic in the one or more ringdown signals.

7. The method of claim 6, wherein the SNR is determined by comparing the harmonic's amplitude to the noise in adjacent frequency bands.

8. The method of claim 1, further comprising adjusting a target parameter of the one or more lasers to correct for instrument drifts, the instrument drifts being identified based on the environmental parameters and observed spectra, and wherein the target parameter is adjusted based on stability of the CES device.

9. The method of claim 8, wherein for identifying the instrument drifts, the method further comprises:
predicting one or more spectral metrics using corresponding pretrained models based on the environmental parameters; and
determining the instrument drifts based on a comparison of the one or more predicted spectral metrics and corresponding observed spectral metrics derived from the observed spectra.

10. The method of claim 9, wherein the instrument drifts is determined by iteratively fitting the one or more predicted spectral metrics and the corresponding observed spectral metrics.

11. The method of claim 8, wherein for identifying the instrument drift, the method further comprises:
processing the environmental parameters through a dense layer and the observed spectra through a convolutional layer of a hybrid model;
combining the processed environmental parameters and the processed observed spectra through a concatenation layer of the hybrid model into combined features; and
identifying the instrument drift based on processing of the combined features through other layers of the hybrid model.

12. The method of claim 11, wherein before combining the processed environmental parameters and the processed observed spectra, the method comprises processing the one or more processed environmental parameters and the processed observed spectra through a corresponding recurrent layer.

13. The method of claim 1, wherein the AI model is trained on a dataset associating any one or a combination of: ratio of absorption values between one or more molecules, absolute absorption value of at least one of the one or more molecules, and the environmental parameters, and wherein the dataset is built by combining empirical data and synthetic datasets.

14. The method of claim 1, wherein the AI model comprises:
a set of ensemble models configured to output an estimated ratio associated with at least one spectral line per species based on the observed spectra and the environmental parameters; and
a meta-regressor model configured to combine the estimated ratio from each ensemble model in the set of ensemble models to determine the chemometrics.

15. The method of claim 1, wherein the AI model is configured to:
process each spectrum from the observed spectra through at least one corresponding convolutional layer;
temporally process each of the processed spectra and the environmental parameters through at least one corresponding recurrent layer;
combine each of the temporally processed spectra and the temporally processed environmental parameters through a concatenation layer; and
determine the chemometrics of the gas sample based on processing of the combined spectra and environmental parameters through other layers of the AI model.

16. The method of claim 1, wherein the CES device comprises a passive membrane-based sampler for collecting the gas sample from a fluid source, and wherein the method further comprises moving the CES device through the fluid source to increase diffusion rate of dissolved gases in the fluid source.

17. The method of claim 1, wherein the passive membrane-based sampler comprises a hydrophobic membrane selected from polytetrafluoroethylene (PTFE) or polydimethylsiloxane (PDMS).

18. The method of claim 1, further comprising:
forecasting ambient gas concentrations in a fluid source from which the gas sample is collected based on environmental telemetry data and the observed spectra over a predetermined interval of time; and
correcting response time based on the forecasted ambient gas concentrations in real time.

19. The method of claim 18, wherein the environmental telemetry data comprises any one or a combination of: ambient temperature, internal temperature, depth-associated pressure, hydrostatic pressure, and salinity.

20. An autonomous underwater vehicle (AUV), comprising:
a cavity-enhanced spectroscopy (CES) device; and
a controller configured to cause the AUV to perform the method of claim 1.
